(19) United States
(12) Patent Application Publication
(10) Pub. No.: US 2025/0017189 A1
(43) Pub. Date: Jan. 16, 2025

(54) FISHING ROD AND REEL HOLDER, SYSTEMS AND METHODS

(71) Applicant: TYLER WALLACE, Chippewa Falls, WI (US)

(72) Inventor: TYLER WALLACE, Chippewa Falls, WI (US)

(21) Appl. No.: 18/351,844

(22) Filed: Jul. 13, 2023

(51) Int. Cl. A01K 97/10

(52) U.S. Cl. CPC A01K 97/10

(57) ABSTRACT

Devices, systems, and methods for holding a fishing rod and reel, including a fishing rod and reel holder having a support member and a holder member rotatably connectable to the support member, the holder member having a first segment, a second segment and a third segment defining an opening sized such that a shank of a fishing reel may pass through the opening, the support members also defining a gap to allow the shank to pass through for insertion or removal of the reel, the holder member configured to rotate to a downward orientation upon a fish strike with the rod sliding forward within the opening, the device configured such that a handle of the rod rests on an uppermost portion of the holder for easy access and removal upon the fish strike.

### BACKGROUND OF THE INVENTION

Fishing rod and reel holders are commonplace. Some holders are considered “tip-ups” and other holders are of a tip-down variety, i.e., the holder or a fishing rod tips downward when a fish is caught. One example of a tip-down type of fish holder is found in U.S. Pat. No. 9,137,978. While this and other devices have benefits, there is room for improvement.

### SUMMARY OF THE INVENTION

The present invention includes a fishing rod and reel holder that is easy to set-up and operate, and provides a means for easy removal of the fishing rod from the holder when a fish is caught. In one aspect the invention includes a device having a holder member which rotates freely about a pin which rotatably connects the holder to an upstanding support member, the holder configured to allow a shank of a fishing rod to sit within an opening of the holder, the shank also being able to pass through a gap of the holder for ease of insertion or removal of the fishing rod from the holder. In aspects the holder is configured to allow a handle of the fishing rod to rest upon an uppermost surface of the holder while the shank is able to slide in or out of the opening via the gap defined by segments of the holder. A user of the device may conveniently and swiftly remove the fishing rod by simply grasping the handle and sliding the shank of the reel laterally through the gap, and without having to also lift the handle from the upper surface of the holder.

In further aspects the invention includes a device having a holder member which rotates from an upward tilt mode to a downward tilt mode to signify a fish strike, where a handle of a fishing rod slides along an upper surface of the holder when a sufficient force is applied to a fishing line of the reel. The force applied to the line, typically due to a catch of a fish, causes the holder member to rotate downward while the rod slides along the holder. A shank of the reel which passes through an opening of the holder slides to a forward position and is held against a segment of the holder by gravity and the force of pull upon the fishing line. Due to rotation downward of the holder member the fishing pole is oriented in a downward manner signifying a fish catch. An operator of the fishing rod and reel may easily grasp the handle of the rod and remove the rod and reel from the holder. In one aspect the rod and reel may be removed by sliding the handle along an upper surface of the holder so that the shank of the reel passes a gap defined by the holder. In other aspects the rod and reel may be removed by grasping the handle and simultaneously lifting away from the upper surface of the holder and translating the handle outward from the holder so that the shank passes a gap of the holder. In aspects, a fishing line extending from the reel passes below the holder while the fishing rod and reel are positioned on the holder. A segment of the holder passes through a space defined by the rod and fishing line and allows for removal of the rod from the holder by sliding the handle along the holder so that the shank passes a gap defined by the holder.

In aspects the shank of the reel may be positioned within the opening and in a spaced relationship with segments of the holder, where the holder member is in a neutral tilt mode. A relatively small force pulling on the line causes the holder member to tilt forward and the handle to slide forward, resulting in a tip-down event occurring and a downward tilt mode. The sliding forward of the shank within the opening to abut against a segment of the holder member causes the rod and reel to be held in position by gravity and/or the force applied to the line. In one aspect a segment of the holder is angled to form a notch in which the shank sets while in the downward tilt mode. An operator may grasp the handle and remove the shank from the notch and through the gap to remove the rod and reel from the device and attend to retrieving the fish. The handle of the rod may slide forward or rearward upon the holder member to accommodate different angles of tilt and thus require different amounts of force to overcome the tipping action, which also adjusts the amount of pull on the line required to cause a tip-down occurrence. This allows the user to set the device to respond with greater (or less) sensitivity to different degrees of pull on the fishing line (corresponding to different sizes of fish that would pull upon the line). In aspects, entire sides of the handle in the area of the opening are exposed when the fishing rod is placed on the holder. A user may grasp the handle with fingers extending around the handle and into the opening from which the shank extends downward. Allowing complete grasp around the handle at the opening allows for ease of manipulation and removal of the fishing rod from the device and easy sliding of a segment of the handle through the space defined by the fishing line and rod.

In further aspects the invention includes a system having a fishing rod positioned on a holder member rotatably connected to an upstanding support, the holder member configured to receive a shank of the reel by passing the shank through a gap of the holder member and placing the handle of the rod on an uppermost surface of the holder member.

In further aspects the invention includes a device having a holder member rotatably affixed to an adjustable support member, the support member fixedly adjustable to a base which allows the support to be secured in a fixed upstanding position, or a fixed collapsed transport position. In aspects the support member nests between slats of the base which includes a lower frame extending outward to provide support or stability to the device.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

FIG. 1 is a perspective view of a device, holder, and system in accordance with aspects of the invention and depicting a representative use and environment.

FIG. 2A, 2B, 2C are side views of the device, holder and system of FIG. 1 shown in representative use modes.

FIG. 3A, 3B, 3C are partial close-up perspective views of the device, holder and system of FIGS. 2A, 2B and 2C.

FIG. 4 is a perspective view of a device and holder in accordance with aspects of the invention.

FIG. 5 is a side view of the device and holder of FIG. 4.

FIG. 6 is an exploded view of the device and holder of FIG. 4.

FIG. 7 is a perspective view of the device and holder of FIG. 4 in a further mode.

FIG. 8 is a top view of the device and holder of FIG. 7.

FIG. 9 is a side view of the device and holder of FIG. 7.

FIG. 10 is a section view taken along line 10-10 of FIG. 8.

FIG. 11 is a section view taken along line 11-11 of FIG. 8.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

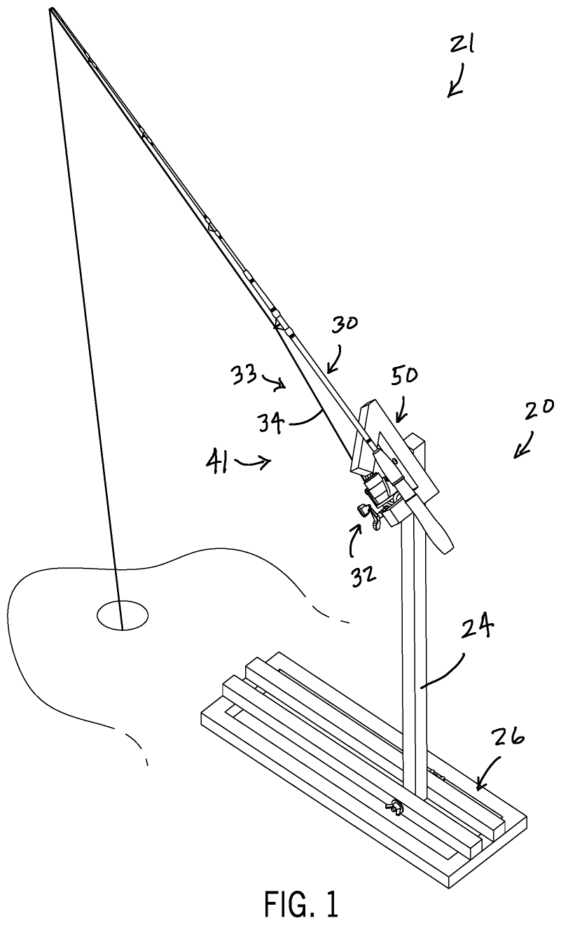

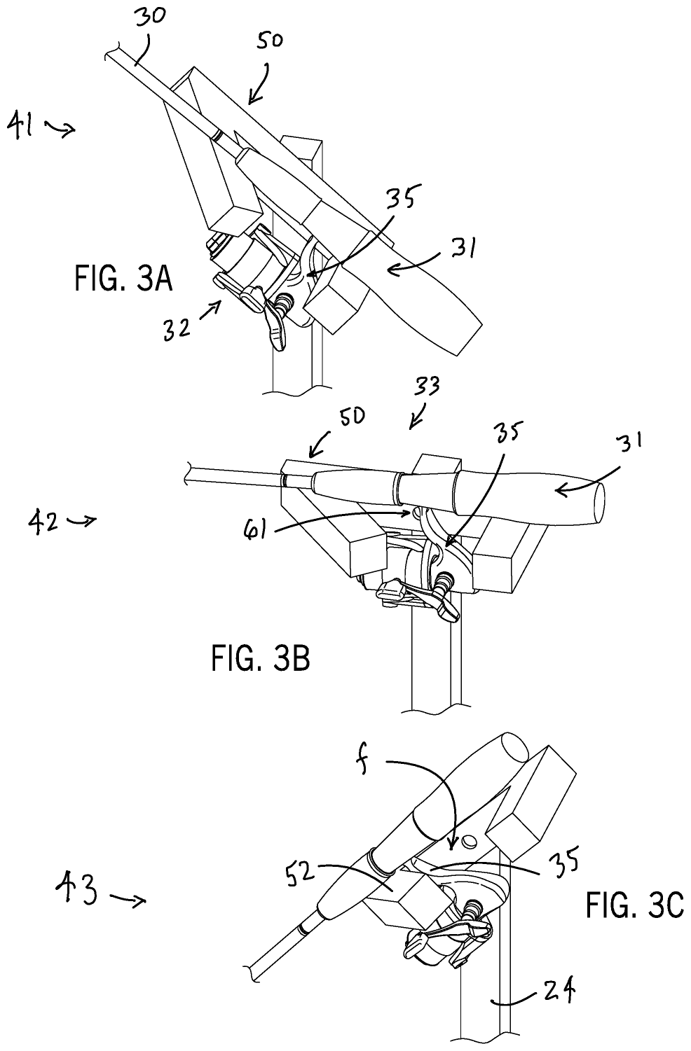

Referring to FIGS. 1-11 aspects of the devices, holders and systems of the invention are shown. In one aspect FIG. 1 shows system 21 which includes a device or holder 20 in conjunction with a fishing rod 30 and fishing reel 32 (i.e., a combined fishing rod and reel 33). The fishing rod and reel 33 include a fishing line 34 wound upon the reel 32 and extending into the water or through a fishing hole as is common. The device 20 includes a support member 24 rotatably connected to a base 26 positioned adjacent the fishing hole. Device 20 further includes a holder member 50 rotatably connected to support member 24. Device 20 is shown with holder member 50 in an upward tilt mode 41 as described further below. Rod and reel 33 may be of any variety of fishing rod and reel, yet work particularly well with a rod and reel 33 variety where reel 32 includes a shank 35 (See FIG. 3A) which connects the reel 32 to the rod 30. Such reel 32 in one aspect is a spinner or spinning-variety of reel, having a bale which opens and closes to release the fishing line as is commonly understood.

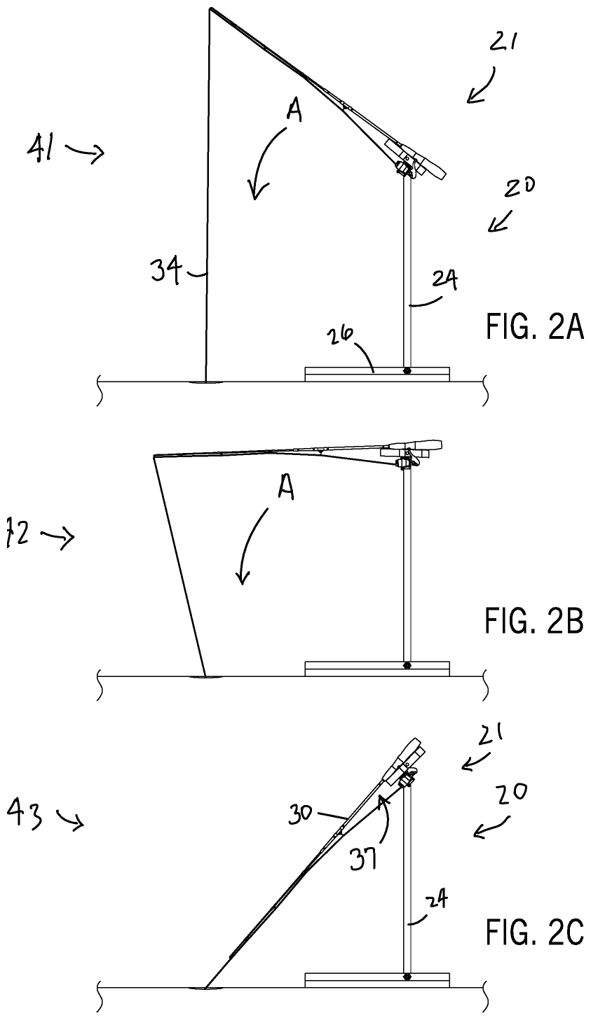

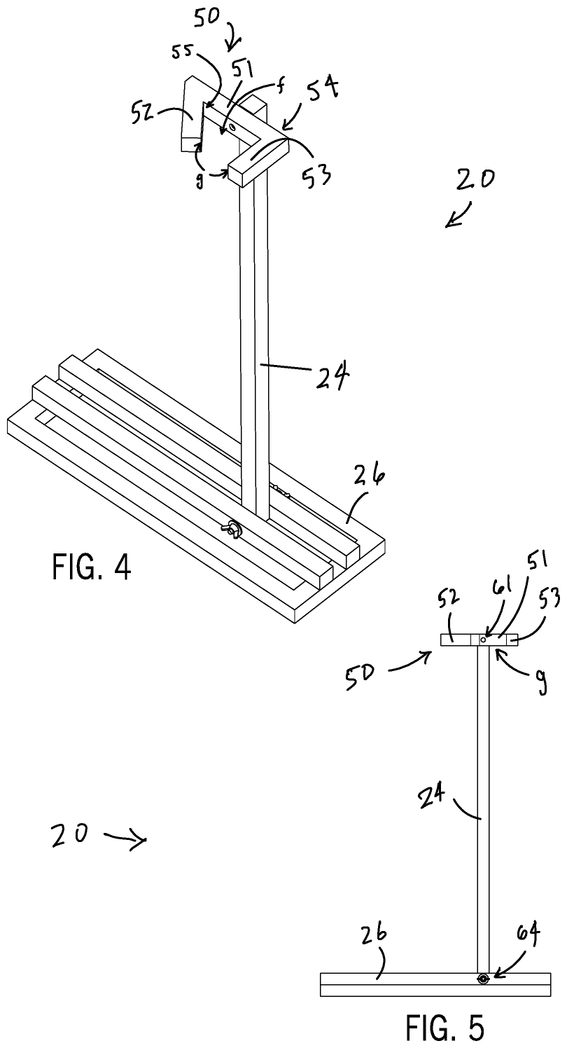

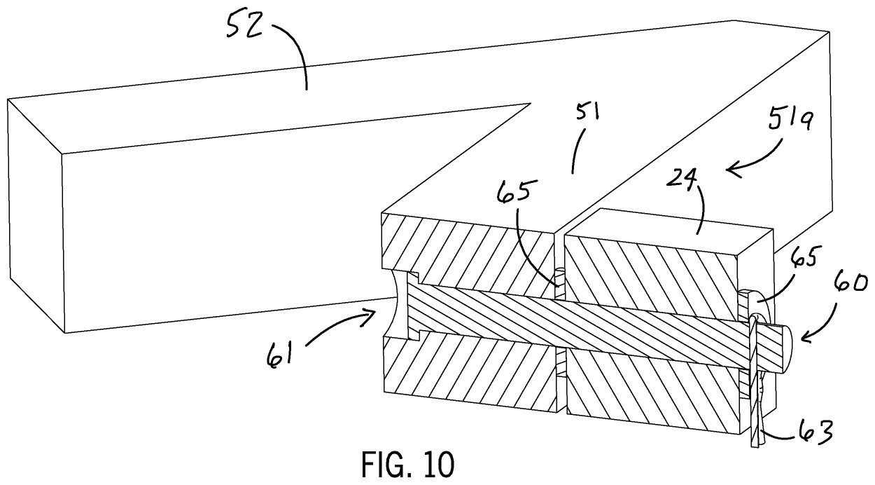

FIGS. 2A, 2B, 2C depict further aspects of the device and holder 20 and system 21 aspects of the invention, including aspects showing holder 20 in the upward tilt mode 41 (FIG. 2A), neutral tilt mode 42 (FIG. 2B) and downward tilt mode 43 (FIG. 2C). FIGS. 3A, 3B, 3C are partial close-up views of FIGS. 2A, 2B, 2C. FIG. 4 is a perspective view of the device 20, and without placement thereon of a rod and reel 33. Holder member 50 of device 20 includes a first segment 51 having a support side 51A (See FIG. 10). The holder member 50 is connected to the support member 24 at the support side 51A. In one aspect, first segment is rotatably connected to the support member 24, and allows holder member 50 to rotate or tilt to various orientations with respect to the support member 24. Holder member 50 includes a second segment 52 extending outward from the first segment 51 in a direction opposite support side 51A. A third segment 53 extends outward from the first segment 51 opposite the support side 51A. In one aspect, first segment 51, second segment 52 and third segment 53 define an opening “f” as shown in FIG. 4. In one aspect, opening “f” is sized such that a shank 35 of fishing reel 32 secured to a fishing rod 30 is positioned within the opening. In aspects, the shank 35 may pass through or pass at least partially through or into opening “f”, which allows the reel 32 to extend downward from holder member 50 while rod 30 is positioned on top of holder member 50. In one aspect, second segment 52 and third segment 53 define a gap “g” where a shank 35 of a fishing reel may be inserted into the holder member 50 by passing the shank 35 through the gap “g”. In one aspect the gap “g’ is defined by a terminal end of the second segment 52 and a terminal end of the third segment 53. In one aspect, gap “g” measures about 2.5 inches. In other aspects gap “g” may measure greater or lesser than 2.5 inches.

As shown in FIG. 1, FIG. 2A, and FIG. 3A, in an upward tilt mode 41 the fishing rod 30 is oriented generally upward while reel 32 abuts rearward against holder member 50. Gravity forces shank 35 against third segment 53. Particularly, a shank 35 of reel 32 abuts against third segment 53 (See FIG. 4) while holder member 50 rotates with respect to support member 24. In such upward tilt mode 41 a fish may pull against line 34, and if enough force is applied to line 34, holder member 50 rotates downward in the direction of arrow A (See FIG. 2A) until rod 30 is oriented in a downward tilt mode 43 as shown in FIG. 2C. The shank 35 of reel 32 abuts against second segment 52 (See FIG. 3C, FIG. 4) in the tilt down orientation of FIG. 2C. In one aspect, and as shown in FIG. 4, second segment 52 forms an acute angle with respect to first segment 51 to define a notch 55. Shank 35, held by gravity, fits securely within notch 55, preventing the rod and reel 33 from falling out of holder member 50.

FIG. 2B and FIG. 3B show rod 50 and holder member 50 oriented in a neutral tilt mode 42. In this aspect, shank 35 is positioned in a spaced relationship with respect to third segment 53 and second segment 52. In such orientation, when a sufficient force is applied downward to line 34, holder member 50 is rotated downward, causing the rod and reel 33 to slide forward toward second segment 52 and into the notch 55 as shown in FIG. 2C, FIG. 3C. Reel 32 is held in position by gravity. Rod and reel 33 and holder member 50 oriented in the down tilt mode signify that a fish has been caught on the line 34 (or at least a force applied downward on the fish line 34 caused the rotation to the downward tilt mode 43). In aspects, device 20 is oriented in the upward tilt mode 41 to account for catching larger fish with more powerful force applied to line 34, whereas a smaller fish which impart a lesser force is less likely or unable to cause the device 20 to switch to downward tilt mode 43 because such force is not sufficient to overcome the rearward balance due to the rod and reel 33 positioned with the shank abutting the third segment 53.

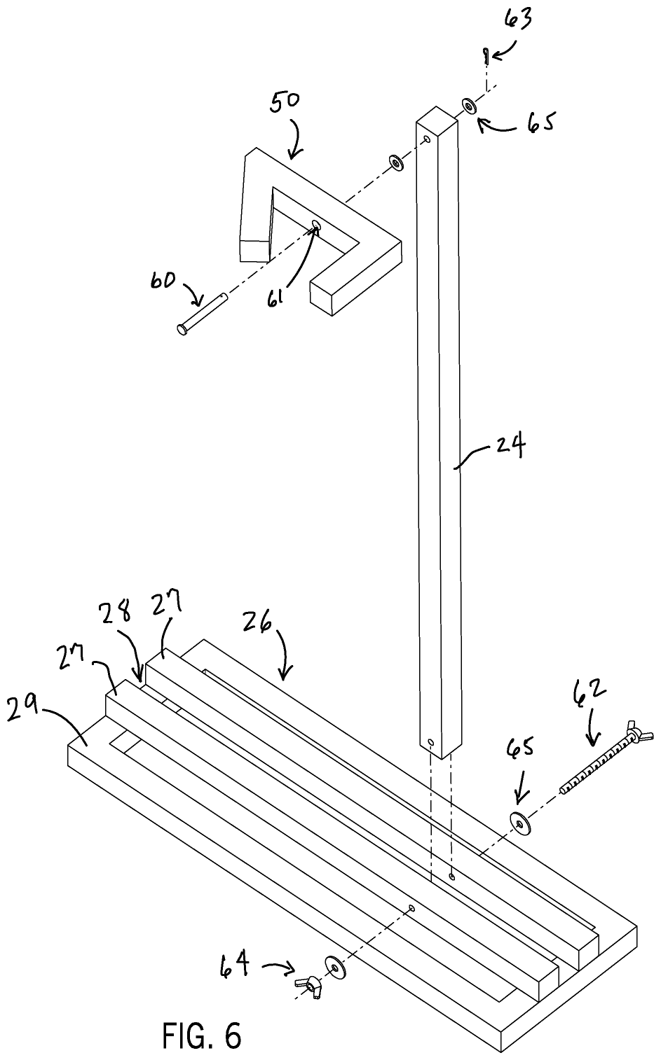

FIG. 5 is a side view of the device 20 of FIG. 4. Holder member 50 is shown in neutral tilt mode 42. In one aspect, holder member 50 is secured to support member 24 with a pin 60 (See FIG. 6) which runs through a pin hole 61. In one aspect, the pin hole 61 is positioned at a midpoint or midsection of first segment 51. In one aspect, pin 60 secures holder member 50 to support member 24 such that holder member 50 may rotate freely about pin 60, without resistance. A washer 65 or washers 65 (See FIG. 6) are used to provide free motion of the holder member 50 about pin 60. A cotter pin 63 secures pin 60 within pin hole 61. In one aspect holder member 50 is configured to rotate 360 degrees around pin 60. In one aspect, holder member 50 is balanced such that holder member 50 will remain in neutral tilt mode 42 when the holder member 50 is set to that neutral tilt position. In one aspect, the mass of second segment 52 balances with the mass of third segment 53 to maintain the neutral tilt position 42. In other aspects, holder member 50 may be tightened against support member 24 (i.e., with a fastener or friction-applying force) to require a greater force to achieve rotation of holder member 50 with respect to support member 24. In aspects, a peg or stopper may also be connected to holder member 50 and/or support member 24 to prevent holder member 50 from over-rotation.

FIG. 3B shows rod and reel 33 in a generally neutral or horizontal mode 42 with the shank 35 positioned within opening “f” and in spaced relationship with respect to third segment 53 and second segment 52. Note shank 35 is located slightly rearward of pin hole 61 which receives pin 60 (See FIG. 6). In aspects, positioning the shank 35 in a rearward position with respect to pin hole 61 or pin 60 causes the balance of mass of the combined rod and reel 33, together with the mass of the line 34 to cause holder member 50 to remain in a neutral tilt mode. Sliding the shank 35 rearward, and away from the equilibrium point, will cause the entire rod and reel 33 to slide rearward upon upward tilt of the holder member 50. Sliding the shank 35 forward, and away from the equilibrium point, will cause the entire rod and reel 33 to slide forward upon downward tilt of the holder member 50. In either case, the handle 31 of rod 30 maintains contact with an upper surface of the holder member 50. In aspects, the handle 31 maintains contact with the uppermost surface of holder member 50, and particularly the uppermost surface of the second segment 52 and/or third segment 53. The handle 31 maintains contact with the upper surface while the shank 35 continues to extend through opening “f” of holder member 50.

FIG. 6 is an exploded view of the device 20, showing holder member 50 securable to support member 24 with pin 60. Support member 24 may be secured to base 26 with a pin or threaded pin 62. A wing nut 64 threads upon a threaded shank of pin 62 to selectively tighten or loosen the force applied to hold support member 24 in an upright (or lowered) position. In one aspect base 26 includes a slat 27 or pair of slats 27, 27 spaced apart to form a slot 28 in which support member 24 inserts for storage or transport of device 20. One end of support member inserts into slot 28 to receive pin or threaded pin 62 which may tighten with wing nut 64 to secure support member 24 in a fixed position. Pin 62 passes through support member 24 and tightening of pin 62 and nut 64 forces slats to compress against support member 24 to hold support member fixed in an upright position or in a travel position or therebetween. Base 26 also includes a frame 29 such that slats 27 are positioned upon the frame 29 and accommodated ease of tightening of support member 24 while providing a wider and mores stable base structure.

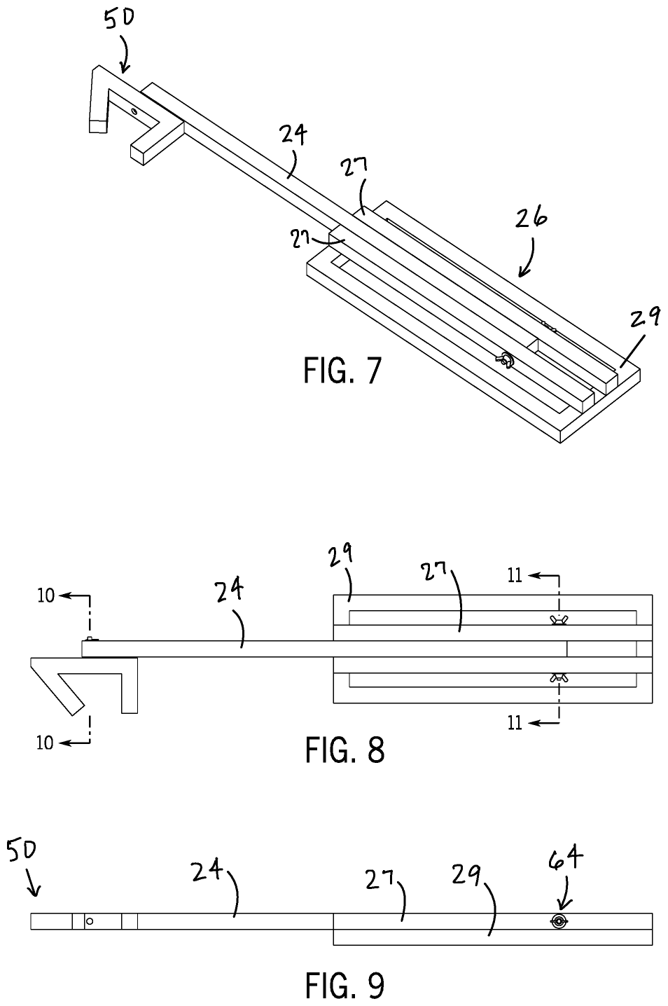

FIG. 7, FIG. 8 and FIG. 9 show device 20 in a storage or transport mode with support member 24 secured in slot 28 and with holder member 50 oriented in alignment with support member 24.

FIG. 10 is a section view taken along line 10-10 of FIG. 8 and shows support member 24 secured with pin 60. Note use of spacers or washers 65 which allows support member 24 to rotate freely. Pin 60 incudes a head which sits within hole 61 against a shelf. Cotter pin 63 retains pin 60 in position while in aspects allowing it to slide within hole 61.

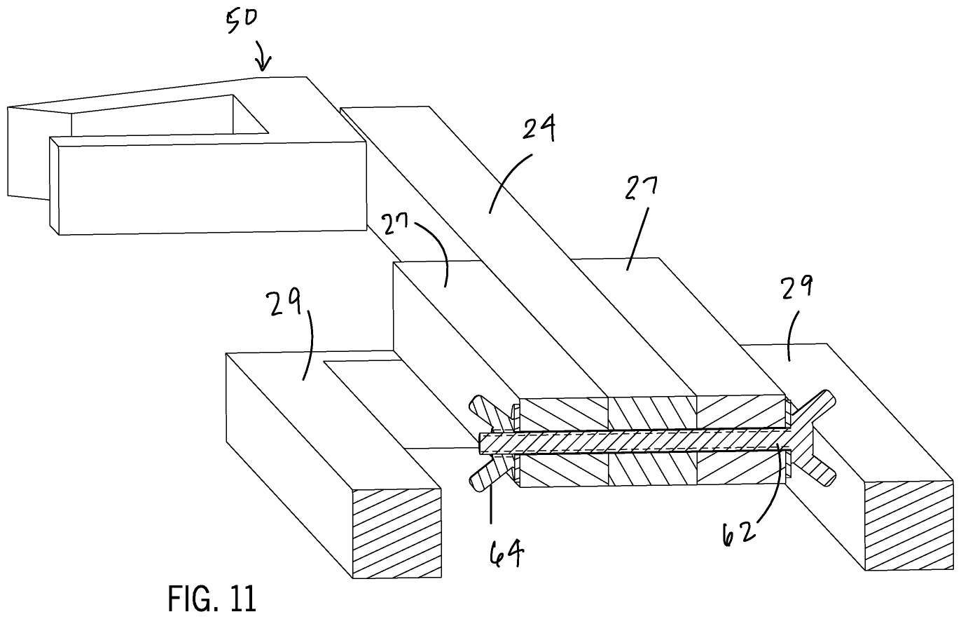

FIG. 11 is a section view taken along line 11-11 of FIG. 8 and shows support member 24 positioned between slats 27, 27 and secured with pin 62. Note there are no spacers or washers between support member 24 and slats 27, 27, thus allowing for hand-tightening of support member 24.

In operation, a user may setup device 20 by loosening pin 62 and extending support member 24 to an upright position generally shown. The device may be placed adjacent a fishing hole. A rod and reel 33 is inserted onto holder member 50 in one aspect by passing shank 35 of reel 32 through the gap “g” in the holder member 50 and placing the handle 31 of the rod on the top of the holder member. A user may grasp the rod at a top portion of the handle 31 and in one motion insert and slide the shank 35 through the gap “g” and into the opening “f”. The user will take care to assure the line 34 of the reel 32 is positioned below the second segment 52 of the holder member 50 so that the fishing line may travel outward from the reel without entanglement by the holder member 50. The user may adjust the tilt of the holder member 50 by selectively placing the handle 31 and shank 35 within the opening “f”, where sliding the shank 35 rearward causes the holder member 50 to tip upwards as shown in FIG. 1. This orientation is desired for catching larger fish and reduces or eliminates false warnings in cases where a smaller force would otherwise pull upon the line and bait within the water of the hole. The user may also orient the holder member 50 in the neutral tilt mode 42, where the shank 35 is positioned more centrally within the opening “f”. Such orientation is desired for catching smaller fish because the device 20 is more sensitive to smaller forces pulling against the line 34 and causing the holder member 50 to tilt downward (causing the rode 30 and shank 35 to slide forward; also causing the shift in mass with respect to the balance point at the pin 60 and the downward tilt in the direction of arrow A). The device 20 being in the downward tilt mode 43 signifies a strike or possible catch of a fish, and the change of orientation is visible from a distance so the fish may be retrieved. Note the rod and reel 33 is situated above the pin 60 and pin hole 61 when in the neutral tilt mode 42 as shown in FIG. 3B. The shank 35 in this configuration is positioned slightly rearward pin hole 61. In other aspects, and for other variations of rods and reels 33, the balance point of where the shank 35 aligns may be at a different location, whether behind or forward the pin hole 61. The user may make slight forward/rearward adjustments to the positioning of the rod and reel 33 and shank 35 to obtain a desired balance, whether horizontally or otherwise. Because the rod and reel 33 is positioned above the pin 60, the device 20 is able to experience a more sensitive adjustment when a fish strikes, causing the rod and reel 33 to slide forward with a tipping downward of the holder member 50.

Upon alert of a tip-down condition and possible catch of a fish, the user may efficiently remove the rod and reel 33 from the holder member 50. Removal is easily accomplished by grasping the handle 31 and simply sliding the rod toward the gap “g” to remove the shank 35 from the opening “f”. A user may grasp the handle by entirely placing fingers around the circumference of the handle 31, or grasp a top portion of the handle (without even lifting the handle) and sliding the handle 31 outward through the gap “g”. Note that a space 37 is defined by the line 34 (extending from the reel 32) and the rod 30. While removing the handle 31, a user may easily allow the second segment 52 to clear through the space 37 (See FIG. 2C) (i.e., because of the space 37, the second segment 52 does not disrupt removal of the rod and reel 33 from the device 20). A user may remove rod and reel 33 by a rearward and outward action of the handle 32 for a swift removal from the device 20.

It should be understood, of course, that the foregoing relates to exemplary embodiments of the invention and that modifications may be made without departing from the spirit and scope of the invention as set forth in the following claims.

1. A fishing rod and reel holder, comprising:
a support member configured to project upright; and
a holder member including a first segment having a support side and a first upper planar surface, the holder member rotatably connectable to the support member at the support side, a second segment extending outward from the first segment opposite the support side and having a second upper planar surface, and a third segment positioned apart from the second segment, the third segment extending outward from the first segment opposite the support side, the first upper planar surface and the second upper planar surface oriented along a common plane, the third segment together with the first segment and the second segment define an opening sized such that a shank of a fishing reel secured to a fishing rod may pass therethrough.

2. The holder of claim 1 wherein a terminal end of the second segment and a terminal end of the third segment define a gap whereby the fishing rod and reel may be inserted onto the holder member by passing the shank of the fishing reel through the gap.

3. The holder of claim 2 wherein the holder member is configured such that the fishing reel may exit the holder member by sliding the fishing rod laterally away from the first segment opposite the support side.

4. The holder of claim 3 wherein the holder member is configured such that the rod may maintain contact with the second segment and/or the third segment while the fishing rod slides away from the first segment.

5. The holder of claim 1 wherein the second segment and the third segment define a gap such that the fishing rod and reel may exit the holder member by passing the shank of the fishing reel through the gap.

6. The holder of claim 5 wherein the holder member is configured such that the fishing rod maintains contact with an uppermost surface of the second segment and/or an uppermost surface of the third segment while the shank passes through the gap.

7. The holder of claim 1 wherein the holder member is configured such that entire sides of a handle of the fishing rod are exposed when the fishing rod is placed on the holder.

8. The holder of claim 1 wherein the third segment includes an uppermost surface configured such that the fishing rod rests upon the uppermost surface while the shank passes through the opening, the uppermost surface being a planar surface oriented along the common plane.

9. The holder of claim 1 wherein the holder member is rotatably connected to the support member by a pin, the holder member rotatable to an upward tilt mode with the second segment oriented above the third segment and rotatable to a downward tilt mode with the second segment oriented below the third segment.

10. The holder of claim 9 wherein the shank abuts the third segment in the upward tilt mode and abuts the second segment in the downward tilt mode.

11. A fishing rod and reel holder, comprising:
a support member configured to project upright; and
a holder member including a first segment having a support side, the holder member rotatably connectable to the support member at the support side, a second segment extending outward from the first segment opposite the support side, and a third segment positioned apart from the second segment, the third segment extending outward from the first segment opposite the support side, the third segment together with the first segment and the second segment define an opening sized such that a shank of a fishing reel secured to a fishing rod may pass therethrough, the holder member rotatably connected to the support member by a pin, the holder member rotatable to a horizontal mode with the second segment oriented at a level with the third segment, the shank is positioned in a spaced relationship with respect to the second segment and the third segment.

12. The holder of claim 1 wherein the support member is rotatably connected to a base.

13. A device for holding a fishing rod having a fishing reel secured thereto, the device comprising:
a support member configured to project upright; and
a holder member including a first segment having a support side, the holder member rotatably connectable to the support member at the support side, a second segment extending from the first segment, and a third segment extending from the first segment, the second segment and the third segment spaced apart to define an opening such that a shank of the fishing reel secured to the fishing rod extends into the opening, the opening configured such that the shank may transition from contact with the third segment to contact with the second segment while the fishing rod or a handle of the fishing rod contacts an upper surface of the second segment.

14. The device of claim 13 wherein a terminal end of the second segment and a terminal end of the third segment define a gap such that the shank may be inserted through the gap and into the opening.

15. The device of claim 13 wherein the second segment forms an acute angle with respect to the first segment to define a notch, the shank positioned within the notch and abutting the second segment when the holder member is rotated to a downward tilt mode.

16. A fishing rod and reel holder system, comprising:
a fishing rod having a fishing reel secured thereto; and
a fishing rod and reel holder, comprising:
a support member configured to project upright; and
a holder member including a longitudinally extending first segment having a support side, the holder member rotatably connectable to the support member at the support side and together with the support member configured to rotate to a T-shaped orientation, a second segment extending from the first segment opposite the support side, and a third segment extending from the first segment opposite the support side, the second segment and the third segment define a gap through which a shank of the fishing reel passes, the fishing rod rests upon an upper surface of the second segment and/or upon an upper surface of the third segment.

17. The fishing rod and reel holder system of claim 16 wherein the fishing rod rests upon the upper surface of the second segment and/or upon the upper surface of the third segment while the shank passes through an opening defined by the holder member.

18. The system of claim 16 where the holder member is configured to rotate to a flat orientation coextensive with the support member.

19. The system of claim 16 where the holder member connects to the support member at a pin hole oriented below the upper surface of the second segment and below the upper surface of the third segment when the holder member is level.

20. The holder of claim 1 wherein the second segment forms an acute angle with respect to the first segment to define a notch, the shank positionable within the notch to abut the second segment when the holder member is rotated to a downward tilt mode.
